(19) United States
(12) Patent Application Publication
(10) Pub. No.: US 2012/0000854 A1
(43) Pub. Date: Jan. 5, 2012

(54) CONTINUOUS REMOVAL OF DISPERSE DYES FROM SOLUTION VIA CARBON-BASED FIBER MEDIA

(75) Inventors: Yibo ZHOU, Ames, IA (US); John G. VERKADE, Ames, IA (US)

(73) Assignee: IOWA STATE UNIVERSITY RESEARCH FOUNDATION, INC., Ames, IA (US)

(21) Appl. No.: 12/828,448

(22) Filed: Jul. 1, 2010

(51) Int. Cl. B01D 15/04

(52) U.S. Cl. 210/660

(57) ABSTRACT

The present invention is directed to a method of removing colorants from a material. The method includes providing colored material, providing an oxoacid or oxoacid ester of phosphorous acid solvent, combining the colored material and the solvent, and agitating under conditions effective to remove the colorant from the colored material. The decolorizing solvent system is continuously refreshed by passing the colored solvent through a carbon column for subsequent recycling.

This invention was made with government support under grant number CHE0750463 awarded by National Science Foundation. The government has certain rights in this invention.

### FIELD OF THE INVENTION

This invention relates to the continuous removal of colorant from solution during decolorization of fabrics using phosphoric and phosphorous acid derivatives.

### BACKGROUND OF THE INVENTION

Efforts have been made to decolorize textile dyes with enzymes (see Ramsay, J., et al., Biotechnol. Lett., 24(21): 1757-1761 (2002); Ramsay, J., et al., Chemosphere, 61(7): 956-964 (2005)) to reclaim textiles, and, for environmental reasons, to decolorize dyes present in waste waters (see Teodorovic, S. et al., Magic World of Textiles, Book of Proc. of the Internat. Textile, Clothing & Design Conf., 1st, Dubrovnik, Croatia, Oct. 6-9, 725-729 (2002)) produced by the textile dyeing industry. Mueller, M., et al., Am. Assoc. of Textile Chemists and Colorists Rev., 1(7): 4-5 (2001) describes the use of an enzyme to decolorize a dye used in a colored fabric manufacturing process. Efforts are also being made by others to use enzymes present in fungi for fabric decoloration (see Teodorovic, S., et al., Magic World of Textiles, Book of Proc. of the Internat. Textile, Clothing & Design Conf., 1st, Dubrovnik, Croatia, Oct. 6-9, 725-729 (2002)). The use of white rot fungi in the decoloration of textile dyes is described in Swamy, J., et al., Enz. and Microb. Tech., 24(3/4): 130-137 (1999)). However, enzymic approaches are slow.

Chemical methods (which are typically faster than enzymes) for removing color from fabrics have long been known and are of the oxidative type (such as bleaching or ozonization) (see for example U.S. Pat. No. 7,550,013). Such chemical methods are by nature stoichiometric, often involve multiple chemicals, and also tend to oxidize the fabric to at least some extent.

Moreover, there is a need for a process that removes the dyes from the decolorizing solvent so that the solvent can be recycled in an environmentally benign and economical manner.

The present invention is directed to overcoming these and other deficiencies in the art.

### SUMMARY OF THE INVENTION

One aspect of the present invention is directed to a method of removing colorants from a material. The method includes providing colored material, providing an oxoacid or oxoacid ester of phosphorous acid solvent, and combining the colored material and the oxoacid or oxoacid ester of phosphorous acid under agitation and conditions effective to remove the colorant from the colored material. The decolorizing solvent system is continuously refreshed by passing the colored solvent through a carbon column for subsequent recycling.

The methods of the present invention are advantageous in that they: (a) are non-oxidative which therefore avoids stoichiometric consumption of the solvent and fabric oxidation, and facilitate recovery of the solvent for recycling; (b) require only one or two reagents which are inexpensive and commercially available; (c) completely decolorize highly colored polyester; (d) recover un-dyed polyester fabric for re-use either as fabric or as depolymerized material for polyester fabric manufacture; and (e) remove color from the decolorizing solvent so that the refreshed solvent can be circulated back to the system to continue the decolorization process.

### BRIEF DESCRIPTION OF THE DRAWINGS

The present embodiments are explained in more detail below with reference to the figures which show exemplary embodiments.

FIG. 1 is a schematic diagram of the solvent re-circulating apparatus of the present invention;

FIG. 2 is a schematic diagram of selected portions of the apparatus shown in FIG. 1;

FIG. 3 is a picture of an assembled carbon U tube section shown in FIG. 1;

FIG. 4 is a picture of the carbon U tube section shown in FIG. 3 which has been disassembled; and

FIG. 5 is a schematic drawing of an impeller pump suitable for use in the present apparatus.

### DETAILED DESCRIPTION OF THE INVENTION

One aspect of the present invention is directed to a method of continuously removing colorants from a material. The method includes providing colored material, providing an oxoacid or oxoacid ester of phosphorous acid, and combining the colored material and the oxoacid or oxoacid ester of phosphorous acid under conditions effective to remove the colorant from the colored material. The colored material and solvent are preferably combined in a container and the container is agitated to remove the colored material. Preferably, the container is a rotatable container and the agitation is preferably provided by tumbling the colored material and solvent to remove the colorant from the material and form a colored solvent. The colored solvent is passed through a charcoal filter to remove colorant from the solvent and the refreshed solvent is re-circulated back to the container.

A preferred embodiment includes adding water to the combined colored material and the oxoacid or oxoacid ester of phosphorous acid under conditions effective to remove the colorant from the colored material.

In certain embodiments, the colored material may be a polymer in the form of a fiber or a textile fiber. Suitable polymers include polyester.

The colorant can be a dye or pigment. Suitable dyes include acridine, anthraquinone, arylmethane, azo, cyanine, diazonium, nitro, nitroso, phthalocyanine, quinone, azin, indamins, indophenol, oxazin, oxazone, thiazin, thiazole, xanthene, fluorene and fluorone. Suitable pigments include alizarin, alizarin crimson, gamboge, indigo, indian yellow, cochineal red, tyrian purple, rose madder, pigment red 170, phthalo green, phthalo blue and quinacridone magenta, and inorganic pigments like cadmium sulfide.

Useful oxoacids of phosphorus include phosphorous acid, phosphoric acid, hypophosphorous acid, polyphosphoric acid, or mixtures thereof.

Suitable oxoacid esters of phosphorous acid are triesters of phosphorus, such as acyclic P(OR)₃, where each R is independently H or a substituted or unsubstituted C₁-C₆ alkyl group, a substituted or unsubstituted alkene group, or a substituted or unsubstituted alkyne group;

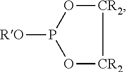

where R′ and each R is independently H or a substituted or unsubstituted C₁-C₆ alkyl group, a substituted or unsubstituted alkene group, or a substituted or unsubstituted alkyne group;

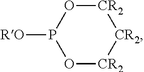

where R′ and each R is independently H or a substituted or unsubstituted C₁-C₆ alkyl group, a substituted or unsubstituted alkene group, or a substituted or unsubstituted alkyne group;

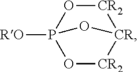

where R′ and each R is independently H or a substituted or unsubstituted C₁-C₆ alkyl group, a substituted or unsubstituted alkene group, or a substituted or unsubstituted alkyne group;

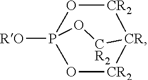

where R′ and each R is independently H or a substituted or unsubstituted C₁-C₆ alkyl group, a substituted or unsubstituted alkene group, or a substituted or unsubstituted alkyne group; and

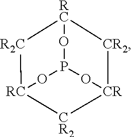

where each R is independently H or a substituted or unsubstituted C₁-C₆ alkyl group, a substituted or unsubstituted alkene group, or a substituted or unsubstituted alkyne group, and mixtures thereof.

The oxoacid or oxoacid ester of phosphorous acid is preferably in an aqueous solution.

In carrying out the method of the present invention, the colorant can be completely removed from the colored material or partially removed from the colored material. Depending on the qualities and quantities of material to be decolored, a skilled artisan can adjust the ratios of decolorant components, the ratios of decolorant to material, adjust the lengths of treatment times, and/or vary the number of repeated treatments (for example, repeating the treatment with a fresh solution of the same or different decolorant) to achieve partial or complete decoloration, as desired.

The conditions effective for removing the colorant from the colored material include treating at a temperature of from about 100° C. to about 200° C., preferably at a temperature of from about 125° C. to about 175° C.

The method of the present invention may include removing the material from the solution after the step of combining the colored material and the solvent. The material can then be washed or rinsed. The washing or rinsing may be carried out by adding a solvent to the material. Suitable solvents include water or an alcohol, e.g., C₁-C₆ alkanols, or mixtures thereof. Suitable solvents include acetone, acetonitrile, dimethylformamide, pyridine, tetrahydrofuran, or mixtures thereof.

It is well known that hydrolysis equilibria are reversible for many chemicals, phosphite esters are no exceptions (see Scheme 1 for example). Thus, the process of the present invention can proceed from left to right in each equilibrium step, starting with, for example, P(OEt)₃ and water or, from right to left, starting from phosphorous acid and ethanol at the lower right of Scheme 1. For example, one can start with 3 equivalents of EtOH and an equivalent of phosphorous acid and, then, remove the water (e.g., with molecular sieves). This produces mainly P(OEt)₃.

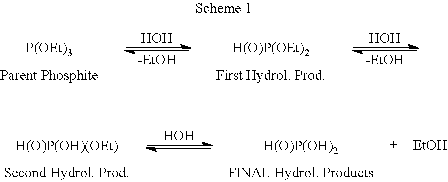

It is possible to start with phosphorous acid and the required alcohol to make a mixture of the first hydrolysis product and the second hydrolysis product or to start with the first hydrolysis product and, by adding the correct amount of water, make the same mixture as starting with phosphorous acid and the required alcohol.

It is generally possible to proceed in either direction of an equilibrium or sequence of equilibria. This process is governed by Le Chatelier's Principle.

It has been shown that the non-toxic first and second hydrolysis products of the toxic bicyclic phosphite P(OCH₂)₃CEt are the active species for effectively solubilizing a wide range of lignocellulosics and are expected to be effective agents for removing colorants from materials.

Synthesis of parent phosphite esters for subsequent hydrolysis (to make the desired ratio of first to second hydrolysis products) requires expense, time, and energy. This can be avoided by starting with phosphorous acid and the desired alcohol, diol, triol, or tetraol, followed by removing the appropriate amount of water. The mixture of decolorizing agents is created by proceeding from the final hydrolysis products and working toward parent phosphites but not actually synthesizing them.

Oxidative bleaching is the current industrial process for decolorization. However, that process is quite expensive and also causes undesirable oxidative destruction of the polyester. Oxidative bleaching could be used in combination with the present methods by employing minimal oxidative bleaching agent after the present methods accomplish complete to virtually complete decolorization.

One skilled in the art would recognize that substitution of a sulfur for one or more oxygens in a phosphorous oxoacid, oxoacid ester, a phosphoric oxoacid, or phosphoric acid ester would be possible as thiophosphorous and thiophosphoric compounds are well known. Such sulfur containing compounds, however, would be more expensive and pose environmental problems.

A preferred de-colorization solvent is a mixture of triethyl phosphite and water which forms mainly diethyl phosphite and ethanol in an equilibrium reaction (equation 1).

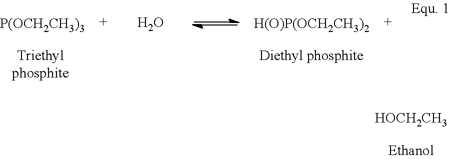

Diethyl phosphite (a hydrolysis product of triethyl phosphite) is the main species responsible for decolorization of dyed polyester fabrics. Although diethyl phosphite is commercially available, triethyl phosphite is considerably cheaper. Because water and ethanol are volatile at 150° C., it would be necessary to carry out the decolorization process in a pressurized apparatus when using a mixture of triethyl phosphite and water. By employing diethyl phosphite by itself (which boils at 204.1° C. at atmospheric pressure) a pressure apparatus would not be necessary.

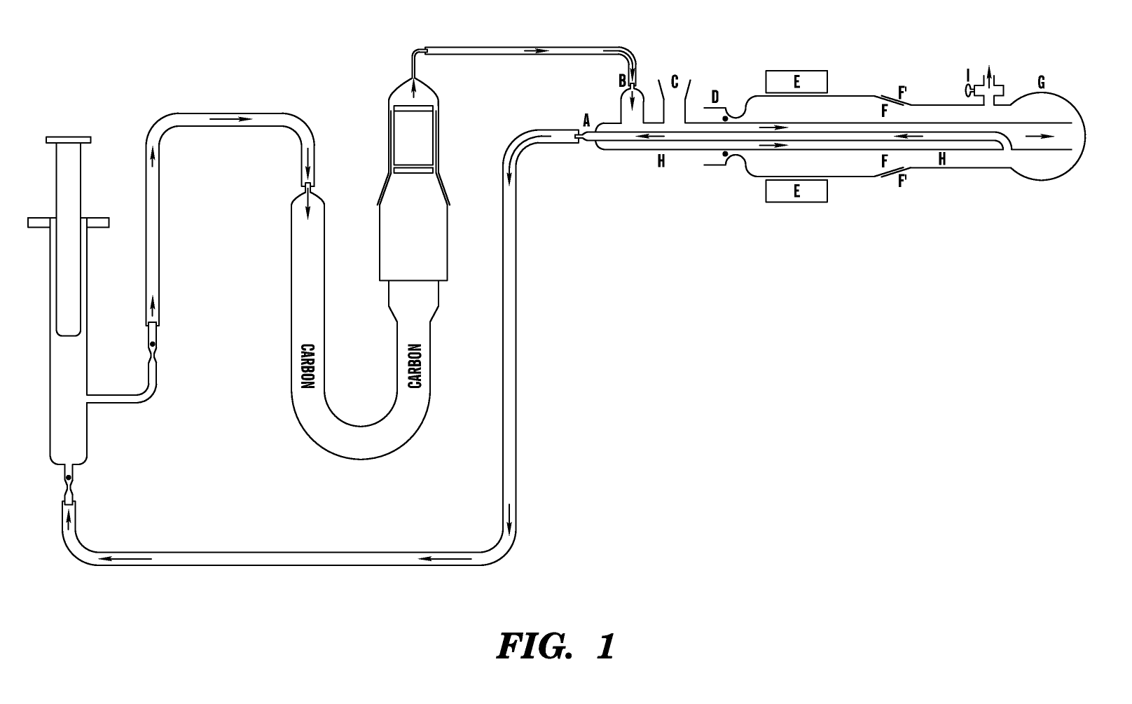

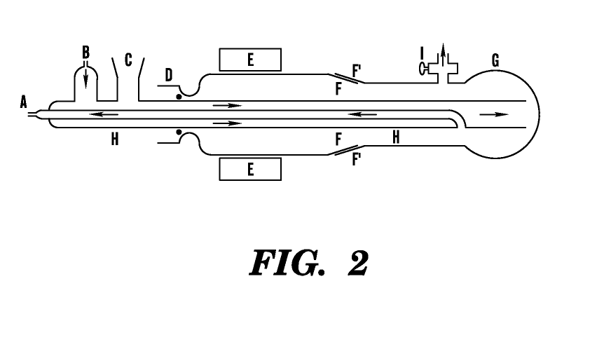

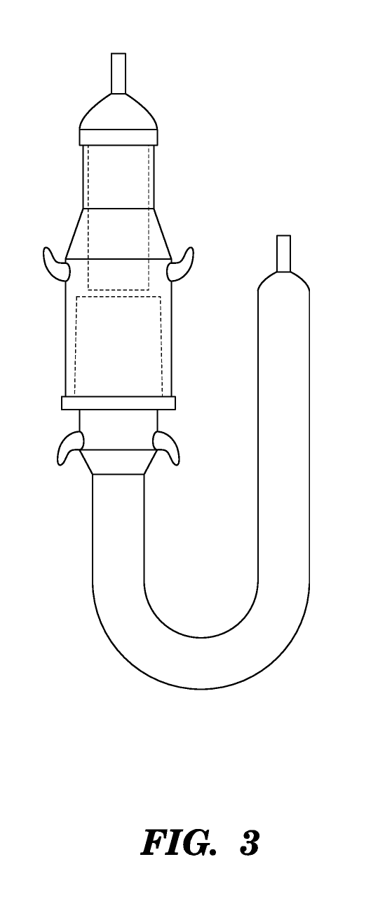

In accordance with an embodiment of the present invention, a continuous decolorizing solvent recycling apparatus, for example as that shown in FIG. 1, is capable of slowly rotating a large (1 liter) reaction flask G (not shown to scale) for tumbling fabric swatches in hot solvent. A Buchi evaporator E shown in FIG. 2 was provided and adjusted to allow agitation by gentle tumbling of the swatches, which prevents mechanical damage to the cloth, which, for example, would have occurred with a paddle or propeller stirrer. Gentle tumbling also promoted good mixing of the decolorizing solvent with the swatches. FIG. 2 shows a schematic of the glass tube assembly that conducts the colored solvent from the rotating flask through the inner glass tube A exhaust port to the tubing that conducts the colored solvent via the syringe pump in FIG. 1 to the charcoal filled U tube shown in FIGS. 1 and 3. The arrows show the direction of fluid flow through the system. The decolorized solvent coming out of the charcoal filled U tube travels back to the flask G via port B as shown by directional arrows. A reflux condenser (not shown) fits into joint C as a safety measure. An o-ring bearing D accommodates rotation of the outer tube and flask G by the Buchi motor. The rotating collar E of the Buchi motor is force fitted to the outer tube connected to flask G. The flask G is connected to the outer tube by standard taper male F and female F″ joints. The extension of double inner tube H is shown in FIGS. 1 and 2. The stopcock I relieves pressure/liquid level changes.

Referring to FIG. 1, the plunger is moved up and down by a high-torque motor fitted to a cam-activated vertical reciprocating slide into which the plunger top is fitted. The barrel of the plunger is held stationary by a stand to which it is fitted. Ball valves maintain fluid flow in a clockwise direction as shown by directional arrows in FIG. 1.

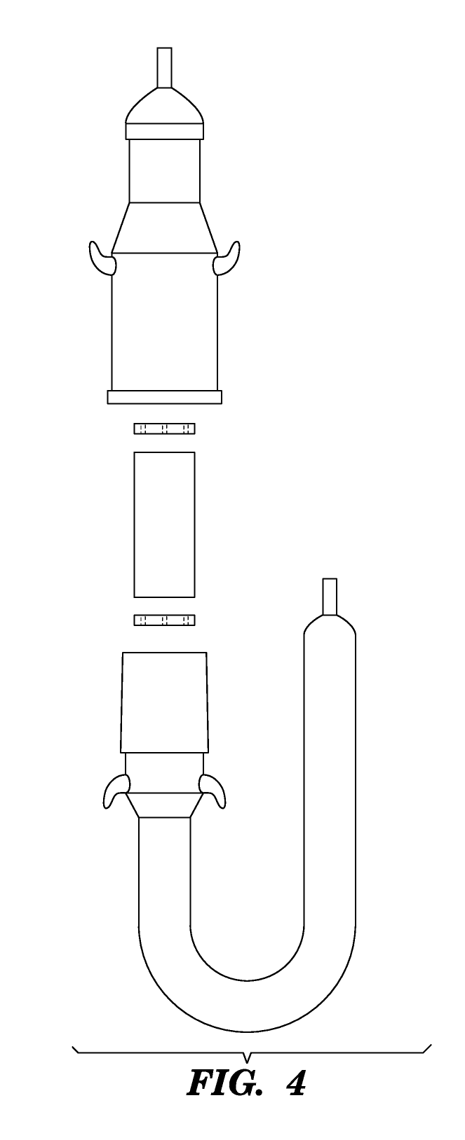

The U tube shown in FIGS. 1 and 3 contains commercial decolorizing charcoal granules. These granules are preferably composed of wood charcoal which is preferred for decolorization over coal- or graphite-based charcoal. Teflon plate 1 and Teflon cup 2 are shown in FIG. 4 with a screw in the center of the bottom of cup 2 for adjustment to provide pressure to cause a tight fit of filter cloths (not shown) against the fritted glass and against the top rim of the male joint. Thin glass-fiber filter cloth prevents carbon particles from exiting the tube and dispersing throughout the apparatus. The standard taper glass joint can be firmly clamped together by an adjustable clamp (not shown). The top of the female standard taper joint contains a coarse glass filter frit, as shown in FIG. 4. The U tube is then filled with carbon until the carbon is level with the rim of the male joint in FIG. 4. A glass fiber cloth filter disc, that is cut to the same diameter as the frit, is held firmly against the bottom of the fit by the top rim of a cylindrical Teflon cup 2 which is shown at the top of FIG. 4. The cup 2 contains a screw in the center of its bottom. The bottom of the cup 2 also had several holes drilled in it to facilitate free fluid flow upwards and through the filter. The length of the screw protruding from the bottom of the cup is adjusted so as to press firmly on a Teflon plate 1 shown in FIG. 4 which rests on the rim of the male joint. The Teflon plate 1 has holes in it to permit fluid flow. A glass fiber cloth filter disc of a slightly smaller diameter than the plate rests on the carbon surface and an aluminum screen of the same diameter is placed on the filter disc. Thus, the U tube preferably contains two filters for more efficient filtration. Preferably, a double-collar adjustable pressure clamp (not shown in FIG. 3 or 4) is used to seal the joint.

Solvent recirculation for the present application could not be done effectively with a common commercially available lab pump that peristaltically “squeezes” the solvent through a flexible tube, because common lab tubing, such as Tygon or polyethylene used for this purpose, are attacked by the solvent. Teflon would be ideal, but it is too stiff for such peristaltic squeezing.

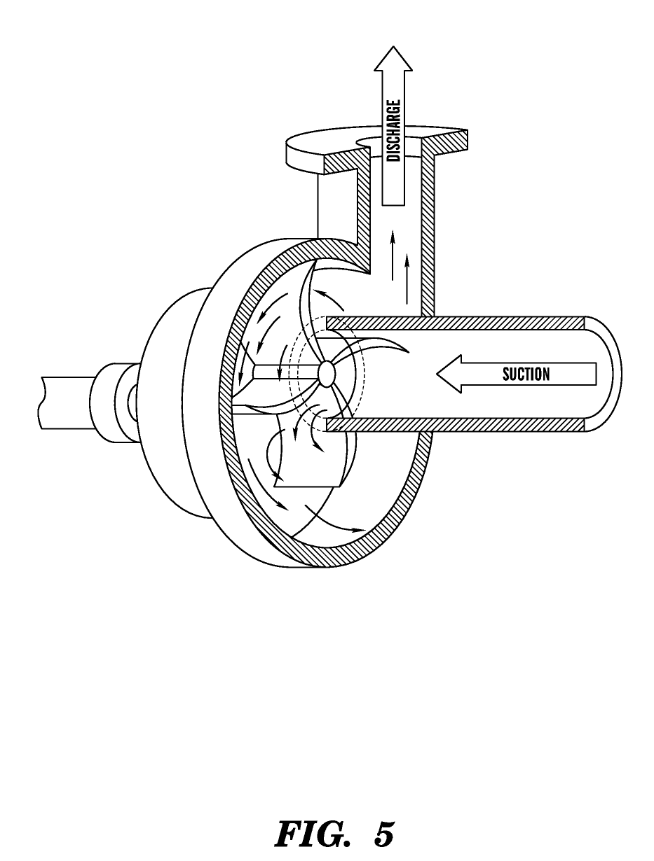

In one embodiment, an all-glass syringe pump, commercially available, equipped with two all-glass ball valves is employed. The placement of the glass ball valves is designed to draw liquid in at the bottom of the syringe barrel through one of the ball valves via upstroke of the plunger, and liquid is pumped out through the side-mounted ball valve on the down stroke, as shown by the directional arrows in FIG. 1. As shown in FIG. 1, the syringe pump is coupled to a slow-speed high-torque motor equipped with a cam mechanism. In another embodiment, a glass/Teflon syringe pump is employed. A Teflon plunger can be fitted to the barrel more closely than a glass plunger. When the diameter of the barrel is not sufficiently uniform, a Teflon plunger on which several tiny flexible “ribs” are left by the lathe, which are somewhat larger in diameter than the rest of the Teflon barrel, and which had diameters slightly larger than the glass barrel itself can be employed. Since the ribs are quite thin, they were flexible and “give” with the uneven terrain of the barrel's interior surface during the up and down strokes. In a preferred embodiment, pumping the solvent through the system can be done with a commercially available Teflon-lined or stainless steel impeller pump, such as that shown in FIG. 5. This pump system is preferably designed such that the impeller portion is submerged in a reservoir of solvent. The solvent level in such a reservoir would be kept at a constant level by continuous return of solvent to the reservoir, thus closing the fluid-flow circuit as well as accelerating solvent recirculation.

Continuous decolorization under pressure can be accomplished by constructing the continuous decolorization apparatus with Teflon and/or stainless steel conduits and components. This system would preferably use either triethyl phosphite/water or diethyl phosphite as the decolorizing solvent.

### EXAMPLES

### Comparative Example A

Batch decolorization. Swatches of dyed polyester were placed in glass pressure tubes followed by covering the swatches with either diethyl phosphite or an equimolar mixture of triethyl phosphite and water. The tubes were then submerged in silicone oil at 150° C. and mechanically tumbled for about 2 hr. After cooling to room temperature, the swatches were removed and washed copiously with ethanol to remove adhering colored decolorizing solvent. Because the swatches had re-dyed on cooling (presumably owing to cooling-induced reclosing of pores containing dye molecules) the decolorization process was repeated. However, even after two repetitions of the decolorization process, the fabrics were still noticeably colored.

### Example 1

A 1-liter flask G as shown in FIG. 2 was charged with 10 variously-colored and patterned swatches of polyester, each about 1 inch wide and 6 inches long. The flask G was then attached to the male joint F in FIG. 2 with small coil springs attached to glass horns fused to both the male and female joints. The flask was then filled with diethyl phosphite via the reflux condenser port C, as shown in FIGS. 1 and 2 until the liquid level submerged the opening at the bottom of the innermost tube extending into the flask G. The syringe pump was then started, thus allowing diethyl phosphite to be withdrawn from the flask through the innermost tube A in FIGS. 1 and 2 through the syringe, through the carbon-loaded tube, into port B in FIGS. 1 and 2 and back into the flask G. While this process proceeded, diethyl phosphite was continuously added to the system to keep the opening to the innermost tube extending into the flask G, below the level of the liquid. Heating of the silicone oil bath below the flask was then begun as was rotation of the flask by the Buchi motor. A clamp mounted on a rack and connected to the tube to which port B was attached prevented tube H in FIGS. 1 and 2 from rotating. While the heating/rotation of the flask was occurring, it was sometimes necessary to stop rotation briefly and vent air via stopcock I in FIG. 2. Once stability in pressure and temperature (about 150° C.) had been achieved, venting was less frequently necessary. When the solvent in the flask had reached a colorless state after a few hours (the time depending on the colors involved, the temperature, and the number of swatches used) the experiment was stopped, the flask was allowed to cool, and the decolorized cloth swatches were removed from the flask, copiously washed with ethanol and vacuum dried. The colorless solvent was recycled for the next experiment.

### Example 2

Using the decolorized solvent from the previous Example 1, the same experiment was repeated for a set of 10 polyester swatches with a different array of colors and patterns, with essentially the same result as in Example 1.

### Example 3

The apparatus was used with a mixture of triethyl phosphite and one equivalent of water (so as to produce an equilibrium mixture containing diethyl phosphite) and was found to be less preferred than that of Examples 1 and 2, since the temperature was controlled by the water/ethanol azeotrope boiling point of 78.2° C. In an industrial setting, a closed pressurized system can be used in which the temperature could be raised to a more desirable level.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A method for continuously removing colorants from a solvent in a system for decolorizing a material comprising:
providing colored material;
providing an oxoacid or oxoacid ester of a phosphorus acid solvent;
combining the colored material and the solvent in a container;
agitating the colored material and solvent in the container under conditions effective to remove the colorant from the colored material and to form a colored solvent;
passing the colored solvent through a charcoal filter to remove colorant from the solvent; and
re-circulating the decolorized solvent back to the container.

2. The method of claim 1, wherein the container is a rotatable container and the agitating is provided by tumbling the colored material and solvent in the container.

3. The method of claim 1, further comprising:
adding water to the combined colored material and the oxoacid or oxoacid ester of a phosphorus acid solvent under conditions effective to remove the colorant from the colored material.

4. The method of claim 1, wherein the colored material is a polymer.

5. The method of claim 4, wherein the polymer is a fiber.

6. The method of aim 5, therein the fiber is a textile fiber.

7. The method of claim 4, wherein the polymer is polyester.

8. The method of claim 1, wherein the oxoacid or oxoacid ester of phosphorous a phosphorus acid solvent is in an aqueous solution.

9. The method of claim 1, wherein an oxoacid of a phosphorus acid is provided.

10. The method of claim 9, wherein the oxoacid of a phosphorus acid is selected from the group consisting of phosphorous acid, phosphoric acid, hypophosphorous acid, polyphosphoric acid, and mixtures thereof.

11. The method of claim 1, wherein an oxoacid ester of a phosphorus acid is provided.

12. The method of claim 11, wherein the oxoacid ester of a phosphorus acid is a triester of phosphorous acid.

13. The method of claim 12, wherein the triester of phosphorous acid is selected from the group consisting of acyclic P(OR)₃, where each R is independently H or a substituted or unsubstituted C₁-C₆ alkyl group, a substituted or unsubstituted alkene group, or a substituted or unsubstituted alkyne group; 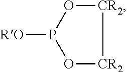
where R′ and each R is independently H or a substituted or unsubstituted C₁-C₆ alkyl group, a substituted or unsubstituted alkene group, or a substituted or unsubstituted alkyne group; 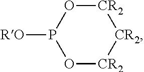
where R′ and each R is independently H or a substituted or unsubstituted C₁-C₆ alkyl group, a substituted or unsubstituted alkene group, or a substituted or unsubstituted alkyne group; 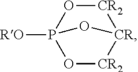
where R′ and each R is independently H or a substituted or unsubstituted C₁-C₆ alkyl group, a substituted or unsubstituted alkene group, or a substituted or unsubstituted alkyne group; 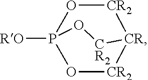
where R′ and each R is independently H or a substituted or unsubstituted C₁-C₆ alkyl group, a substituted or unsubstituted alkene group, or a substituted or unsubstituted alkyne group; and 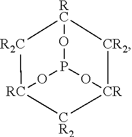
where each R is independently H or a substituted or unsubstituted C₁-C₆ alkyl group, a substituted or unsubstituted alkene group, or a substituted or unsubstituted alkyne group, and mixtures thereof.

14. The method of claim 1, wherein the colorant is completely removed from the colored material.

15. The method of claim 1, wherein the colorant is partially removed from the colored material.

16. The method of claim 1, wherein said effective conditions comprise a temperature of from about 100° C. to about 200° C.

17. The method of claim 16, wherein said effective conditions comprise a temperature of from about 125° C. to about 175° C.

18. The method of claim 1 further comprising:
removing the material from the solution after said combining and
washing or rinsing the material.

19. The method of claim 18, wherein said washing or rinsing comprises:
adding a solvent to the material.

20. The method of claim 19, wherein said solvent is water or an alcohol.

21. The method of claim 20, wherein said solvent is a C₁-C₆ alkanol.

22. The method of claim 19, wherein said solvent comprises at least one organic solvent.

23. The method of claim 1, wherein said colorant is a dye.

24. The method of claim 1, wherein the charcoal filter comprises granules of wood charcoal.
